(19) United States
(12) Patent Application Publication
(10) Pub. No.: US 2006/0060033 A1
(43) Pub. Date: Mar. 23, 2006

(54) Disc shaped ratchet wrench

(76) Inventors: Mark S. Warner, Mission Viejo, CA (US); Paul W. Petersen, Costa Mesa, CA (US)

Correspondence Address: CHARLES C.H. WU, 98 DISCOVERY, IRVINE, CA, 92618-3105, US

(21) Appl. No.: 11/226,512

(22) Filed: Sep. 14, 2005

Related U.S. Application Data
(60) Provisional application No. 60/611,505, filed on Sep. 21, 2004.

(51) Int. Cl. B25B 13/46

(52) U.S. Cl. 81/60

(57) ABSTRACT

A disc shaped ratchet wrench device has an outer concentric member disposed at the outer circumference and formed substantially concentrical to a center of the disc shaped ratchet wrench device. The device further has an inner member disposed within the outer concentric member. The inner disc has a driving element rigidly affixed to the center of the disc shaped ratchet wrench device. Whereby, when the outer concentric member is rotated, the inner member and the driving element rotate in conjunction with the outer concentric member for tightening or loosening of a work piece.

### REFERENCE TO RELATED APPLICATIONS

This application claims an invention which was disclosed in Provisional Application No. 60/611,505, filed Sep. 21, 2005, entitled “POCKET PRO RATCHET WRENCH”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of ratchet wrench. More particularly, the invention pertains to an improved compact ratchet wrench.

2. Description of Related Art

Detachable handle socket ratchet wrench is known. U.S. Pat. No. 6,378,400 to Bogli describes a detachable handle socket ratchet wrench system for permitting a user to change handles to suit the needs of the user. The detachable handle socket ratchet wrench system includes a ratchet head with a tubular sleeve outwardly extending therefrom defining a receptacle. A plurality of elongate handles is provided each having an insertion portion adjacent a distal end of the respective handle. The insertion portion of each of the handles is insertable into the receptacle of the sleeve. Each of the handle has a length defined between the proximal and distal ends of the respective handle. The length of a first of the handles is greater than the length of a second of the handles and at least two times greater than the length of a third of the handles. The length of the third handle is greater than about one-half the length of the second handle and less than about four-fifths the length of the second handle.

Wrench socket lever is also known. U.S. Pat. No. 6,085,618 to Macor describes a hand wrench for attachment with various sockets and other hand tool attachments to control the rotation of fasteners. The hand wrench has a main member with dimensions of length greater than width, and width greater than thickness such that it has a thin stamped form; and, a driving element fixed to and protruding out from the main member and formed to engage with sockets and other hand tool attachments. In some preferred embodiments, the main member is wider at one end and is bent offset with an obtuse angle of about 170 degrees. Because this hand wrench has a thin stamped form without a ratcheting mechanism, said hand wrench can access and engage fasteners under certain limited-access situations where a ratchet wrench (or any other known wrench) cannot. Additionally, the simple design and form allows the present invention to be manufactured at a much lower cost than a ratchet wrench or flex “T” handle, whereby providing the consumer with an inexpensive alternative to a ratchet wrench or flex “T” handle.

Furthermore, specific usage hand tools such as a faucet handle tool is also known. U.S. Pat. No. 5,862,721 to Kowats describes a faucet handle turning tool having a cylindrically-shaped body member with a cavity in one end. The cavity has sidewalls which taper inwardly to engage a faucet handle. There is a hexagonal head on one end of the cylindrical body to receive a wrench, which provides the turning movement to turn the body member. A square bore is disposed within the hexagonal head to receive a ratchet drive which can provide the rotating driving movement to the hexagonal head. By utilizing separately provided ratchet or wrench drive means, the faucet handle tool requires only a minimum amount of storage space within a tool box.

In the everyday usage of a wrench, there may be multiple needs or purposes for the wrench. In a lot of cases, the space available for applying the wrench is limited in that commonly available ratchet wrench generally cannot used because of spatial limitations. Or, alternatively the commonly available ratchet wrench cannot be used with ease because of its mechanism, size or shape. In light of the above limitations, it is desirous to have an improved ratchet wrench that has simple mechanism adapted for use with other commonly available and suitable tools. It is further desirous to have an improved ratchet wrench that can be used in a limited space and easy to use as well as to store.

### SUMMARY OF THE INVENTION

A substantially disc shaped member is provided with a simple mechanism adapted for interfacing with other commonly available and suitable tools.

A substantially disc shaped member is provided for ease of carrying and manipulation.

A substantially disc shaped member is provided with a recesse for disposing a socket drive therein.

A disc shaped ratchet wrench device has an outer concentric member disposed at the outer circumference and formed substantially concentrical to a center of the disc shaped ratchet wrench device. The device further has an inner member which includes an inner member that is lodge within the disc or disposed within the outer concentric member. The inner disc has a driving element rigidly affixed to the center of the disc shaped ratchet wrench device. Whereby, when the outer concentric member is rotated, the inner member and the driving element rotate in conjunction with the outer concentric member for tightening or loosening of a work piece.

### BRIEF DESCRIPTION OF THE DRAWING

FIG. 1 shows perspective view from the top of the present invention.

FIG. 2 shows perspective view from the bottom of the present invention.

FIG. 3 shows a handle of the present invention.

FIG. 4 shows a sectional view of FIG. 2.

FIG. 5 shows a limited angular space for applying the handle of FIG. 3.

### DETAILED DESCRIPTION OF THE INVENTION

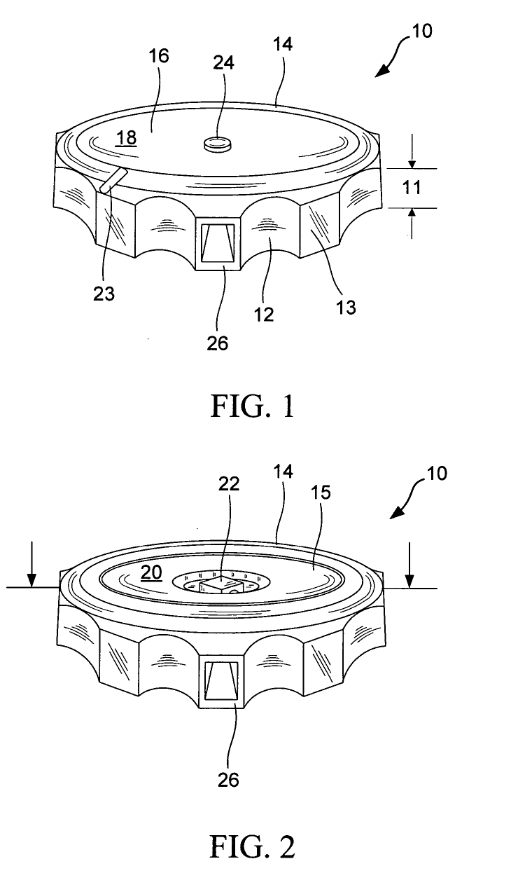

Referring to FIGS. 1-5, a compact disc shaped ratchet wrench 10 is shown. Compact disc shaped ratchet wrench 10 has a substantially circular or disc shape. Wrench 10 is preferably of a compact or a suitable size for suitable hand manipulation. Compact disc shaped ratchet wrench 10 has a thickness 11 or height giving the same a cylindrical shape defining a recess which is described in detail infra. Notches 12 and teeth 13 are formed on or around the outer or exterior circumference of compact disc shaped ratchet wrench 10. The notches 12 and teeth 13 may be used to provide a secure or slip resistant grip. The grip may be achieved by placing some of the fingers of a hand thereon for twisting or turning such that a bolt (not shown) with a socket such as a commonly available socket out of a set of the same may be fastened or loosened as the case may be.

Within notches 12 and teeth 13, an inner ring 14 is formed out of the same material as that of notches 12 or formed out of a different material that is rigidly attached to notches 12. Inner ring 14 has an inner surface 15 or wall opposite to the outer surface of notches 12 and teeth 13 that is touching the fingers of a hand for manipulation of compact disc shaped ratchet wrench 10 as described supra.

In alternative embodiments, Inner ring 14 may have non-circular outer contour that fits into an inner wall of the out member having notches 12 and teeth 13. The outer contour may be oval shaped or of any other suitable shape. Inner ring 14 may also have a circular opening that is hollowed out and having a commonly available ratchet drive fitted at the center ratchet wrench 10.

While the notches 12 or teeth 13 are convenient elements of the present invention, they are not absolutely necessary for the implementation of the present invention. Any element suitable for hand gripping is contemplated by the present invention. For example, a disc having a rough outer surface suitable for hand grip is contemplated by the present invention.

Referring back now to the referred embodiment, compact disc shape ratchet wrench 10 further has an inner member 16 having its outer circumference rigidly connected to a top portion of the inner circumference of inner ring 14. Inner ring 14 and inner member 16 may be formed out of similar material. Inner member 16 is substantially thinner than thickness or height 11 of compact disc shaped ratchet wrench 10, whereby only a top portion of the inner circumference of inner ring 14 is connected with inner disc 16. Inner member 16 possesses an outer surface 18 and an opposing inner surface 20.

A button 24 is located on the top center of the compact disc shaped ratchet wrench 10. In other words, button 24 is located on the outer surface 18 side of inner member 16. Button 24 may be used for allowing a socket (not shown) to engage and/or release the attached socket from recessed socket engagement square drive 22. A switch lever 23 on the side of compact disc shaped ratchet wrench 10 such as on the inner ring 14 is provided. Lever 23 possesses two switching positions: a first position enables a user to ratchet compact disc shaped ratchet wrench 10 clockwise, and a second position enables the user to ratchet compact disc shaped ratchet wrench 10 counter-clockwise for loosening or tightening a nut or a bolt as the case may be.

One advantage of the present invention is that a recessed socket engagement square drive 22 is formed within a recess defined by the cylindrical shape of the inner recess. Because of the recess, less space is required for positioning a socket such as a commonly available socket to fit into a limited space. Whereby, a user can use the compact disc shaped ratchet wrench 10 in limited access conditions or locations in that wrench 10 can fit into a more limited space. The recess is defined by inner surface 20, and the inner surface 15 of inner ring 14. The recess may be cylindrically shaped that has an open end and a closed end. The closed end is defined or limited by inner surface 20 of inner member 16. At the center of the closed end, the square drive 22 is formed for attaching to a set of suitably shaped, standardized sockets (not shown). Depending on the size of the standardized sockets, the same may or may not extend out of the open end of the cylindrical recess depending on the thickness 11 of the disc. However, generally speaking thickness 11 is shorter than the length of the socket. Recessed socket engagement square drive 22 is positioned on the inner surface 20 side of the recess thereby providing more space for the commonly available sockets to be attached thereon. In other words, square drive 22 takes less space this way than a disc with the recess. For example, with no collapsed in recess, square drive 22 necessarily protrude more in an outward direction whereby taking more space. Therefore, more space is provided because the inner member 16 is thinner than thickness 11 of compact wrench 10, thereby providing space for the cylindrical recess.

As can be seen, a top view of compact disc shaped ratchet wrench 10 is shown in FIG. 1; and a bottom view of compact disc shaped ratchet wrench 10 is shown in FIG. 2. Disc shaped ratchet wrench 10 may be a conveniently sized compact ratchet wrench. For example, a pocket sized compact disc shaped ratchet wrench 10 in that compact disc shaped ratchet wrench 10 may be carried about in ones pocket instead of placed within and carried about in a tool box. Compact disc shaped ratchet wrench 10 may be a compact ratchet wrench for tightening and loosening any nuts and bolts. Compact disc shaped ratchet wrench 10 may be able to fit into the palm of a hand. A user may use her hand to operate wrench 10 by placing some of her fingers in-between the notches at the outer circumference of compact disc shaped ratchet wrench 10 and twisting the same, i.e. disc shaped ratchet wrench 10.

A user may also use the circular shaped compact disc shaped ratchet wrench 10 for tightening and loosening a worked upon piece by spinning the disc shaped compact disc shaped ratchet wrench 10. By manipulating one's fingers in an efficient manner, the user turns or manipulates her fingers in an easier or quicker manner than moving her wrist and/or elbow. However, if wrist or elbow power is required, a handle 25 may also be provided in the present invention for greater leverage. Therefore, a handle engagement square socket 26 is formed on the outer circumference of compact disc shaped ratchet wrench 10 for receiving and engaging the handle 25. Handle engagement square socket 26 may be formed in an opening on a tooth 13 of compact disc shaped ratchet wrench 10.

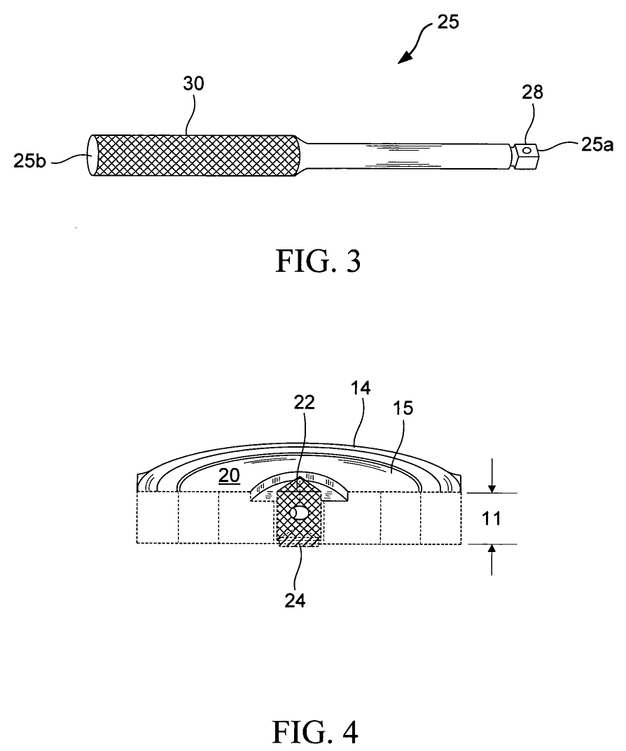

Referring specifically to FIG. 3, handle 25 is disposed to attachably engage compact disc shaped ratchet wrench 10 via the handle engagement square socket 26 on the side of compact disc shaped ratchet wrench 10. Handle 25 has a generally elongated shape and comprises a distal end 25a and a proximal end 25b. On the distal end 25a, a square drive 28 is formed for engaging the handle engagement square socket 26 of compact disc shaped ratchet wrench 10. On the proximal end 25b, a handle 30 is formed with the surface of the same operable for suitable hand griping. If the handle 25 is not at hand or easily reached or accessible, any other similar elongated tools with a suitable drive for engaging the handle engagement square socket 26 may be used.

Referring specifically to FIG. 4, a sectional view of FIG. 2 is depicted. Square drive 22 is intersected diagonally. Also note the cylindrical space or recess defined by inner surface 20, and the inner surface 15 of inner ring 14 for providing more manipulating space.

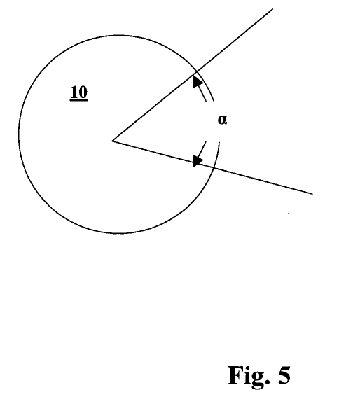

Referring specifically to FIG. 5, a limited angular space for applying the handle 25 of FIG. 3 is shown. An angle α depicts the angular limitation of applying handle 25 on compact disc shaped ratchet wrench 10. Angle α ordinarily is an acute angle, but it may be an obtuse angle. Therefore, when handle 25 or any other suitable lever is limited in angular movement as such, handle engagement square socket 26 may be placed within the proximity of angle α for suitable engagement with handle 25. Compact disc shaped ratchet wrench 10 may be comprised of various materials such as metals, metal alloys, and other suitable materials.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A disc shaped ratchet wrench device comprising:
an outer concentric member disposed at the outer circumference and formed substantially concentrical to a center of the disc shaped ratchet wrench device; and
an inner member disposed within the outer concentric member having a driving element rigidly affixed to the center of the disc shaped ratchet wrench device;
whereby when the outer concentric member is rotated, the inner member and the driving element rotate in conjunction therewith.

2. The disc shaped ratchet wrench device of claim 1, wherein the inner member comprises a first surface and an opposing second surface with a thickness defined as a distance between the two surfaces, the thickness being thinner than a predetermined thickness of the outer member; thereby forming a recess for affixing the driving element therein.

3. The disc shaped ratchet wrench device of claim 1, wherein the outer concentric member has an outer surface having an ease for griping element formed thereon.

4. The disc shaped ratchet wrench device of claim 3, wherein the ease for griping element comprises notches and/or teeth.

5. The disc shaped ratchet wrench device of claim 3, wherein the outer surface has a receiving element for receiving an elongated lever member.
